(19) United States
(12) Patent Application Publication
(10) Pub. No.: US 2020/0143716 A1
(43) Pub. Date: May 7, 2020

(54) Reflective / Protective license plate and method of making.

(71) Applicants: Xin Zhi Li, London (GB); Andre Jean, Paris (FR)

(72) Inventors: Xin Zhi Li, London (GB); Andre Jean, Paris (FR)

(21) Appl. No.: 16/676,323

(22) Filed: Nov. 6, 2019

Related U.S. Application Data
(60) Provisional application No. 62/757,129, filed on Nov. 7, 2018.

(51) Int. Cl. G09F 13/16; B60R 13/10; G02B 3/00

(52) U.S. Cl. CPC G09F 13/16; G02B 3/005; B60R 13/105

(57) ABSTRACT

This invention is directed toward a novel license plate that has both superior optical qualities and security features that make it very difficult to counterfeit. The license plate has three basic layers: an outer layer of lenticular material and provides a lenticular optical display, a middle layer of reflective material that is very difficult to duplicate, thereby providing enhanced security characteristics to make counterfeiting very difficult, and a base layer made from aluminum which provides structural stability.

### CROSS REFERENCE TO RELATED APPLICATIONS

This utility patent application claims priority back to U.S. Provisional Application No. 62/757,129 filed 7 Nov. 2018, the contents of which are incorporated by reference.

### STATEMENT REGARDING FEDERALLY SPONSORED RESEARCH OR DEVELOPMENT

This invention was not federally sponsored.

### BACKGROUND OF THE INVENTION

### Field of the Invention

This invention relates to the general field of multi-layer metal items, and more specifically, to a reflective license plate with additional security, durability, and protective features.

### Problem Addressed

Current license plates provide visible numbers and letters, but the optical qualities are not much better than a common sign. They are visible to other drivers, pedestrians and the police, but do not provide ideal optics and, because of their simplicity, are quite easy to counterfeit. Thus, there has existed a long-felt need for a license plate with superior visibility combined with a license plate that is very difficult to counterfeit.

### Solution

The current invention provides just such a solution by teaching a novel license plate that has both superior optical qualities and security features that make it very difficult to counterfeit. The license plate has three basic layers: an outer layer of nom optics material and provides a optical display, a middle layer of reflective material that is very difficult to duplicate, thereby providing enhanced security characteristics to make counterfeiting very difficult, and a base layer made from aluminum which provides structural stability.

### BRIEF DESCRIPTION OF INVENTION

The invention provides a visible device—a preferred embodiment being a license plate for an automobile where very high precision, micro optical printing produces a license plate with superior characteristics to the license plates currently in use. The license plate in the preferred embodiment has three basic layers: a base layer made from, preferably, aluminum which provides structural stability, a layer of reflective material that provides the enhanced visibility and security characteristics, and an outer layer of optical structure material and provides a desired optical display in addition to providing an attractive appearance, a more durable end product, and also allowing for anti-counterfeiting characteristics. The micro optical printing allows for easy counterfeit detection by both the naked eye and police digital detection means, as the micro optical structure causes retroreflective light to be diffused, creating a dark area that is easily detectable by current police license plate readers and traffic cameras/sensors. The features can be easily visible at good lighting condition, and also visible with a help of light source, for instance, a handheld torch, when the lighting condition is poor.

The micro optical feature can cover either all, or just a part of the license plate. Oncoming light is diffused by the micro-optical portions of the license plate, creating a “dark area”, which is easily visible to a human, such as a police officer, or to a traffic camera. The embodiment of the invention in which only a portion of the license plate is covered by the micro-optical features can be created by placing the micro-optical features on only a portion of the license plate, or placing them on the entire license plate and then removing them on the portions where micro-optical features are not desired.

### OBJECTS OF THE INVENTION

It is therefore an object of the present invention to provide a license plate with optical qualities that provide superior visibility compared with license plates currently available.

An additional object of the invention includes providing a license plate that is difficult to counterfeit.

A further object of the invention is to provide a license plate where the legitimacy of the license plate can be read by both the naked eye and police/traffic optical readers.

An additional object of the invention is to provide a license plate with localized micro optical features that create a dark area that can be detected by both traffic cameras and the naked eye.

A further object of the invention is to provide a license plate that can be partially or fully covered by the micro optical structure.

An additional object of the invention is to provide

Another object of the invention is to provide a license plate that is more attractive than the ones in the prior art.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

### BRIEF DESCRIPTION OF THE FIGURES

One preferred form of the invention will now be described with reference to the accompanying drawings.

FIG. 1 is a cross-sectional view of a license plate with a micro-optical outer surface, which is used in a preferred embodiment of the invention, but not in any way meant to limit the relevance of this claimed technology to other fields. In FIG. 1, there are three basic layers, a backing layer 4 which provides support for the license plate, a middle layer 3 which in this figure provides reflection such that the license plate is more visible at night, and an outer layer 2.

FIG. 2 is a front view of a license plate, showing a preferred embodiment of the invention.

FIG. 3 is a cross-sectional view of another embodiment of the invention with five layers.

FIG. 4 is a perspective, partial cut-away view of the invention.

FIG. 5 contains a cross-sectional view of one embodiment of the invention showing different lens aspects.

FIG. 6 contains a cross-sectional view of another embodiment of the invention showing different lens aspects.

FIG. 7 is a cross-sectional view of yet another embodiment of the invention showing different lens aspects.

FIG. 8 is a front view of a license plate with several optical structures embedded in it.

The Backing layer is preferably made from aluminum or another lightweight but strong metal, plastic or composite. The middle layer is reflective, such that headlights and other sources of light at night will illuminate the numbers of the license plate well. The outer layer has one or more of a set of optical properties that will further enhance visibility, as well as provided a decorative purpose, anti-counterfeiting features and extended durability of the license plate.

There are a number of variables that can be combined in different ways to provide a final product with different characteristics to suit a particular purpose. For example, a preferred embodiment with superior visibility, durability and anti-counterfeiting characteristics comprises an outer layer, a middle layer and a backing layer, where the outer layer is comprises an optical structure, where the middle layer is a reflective layer, and where the base layer is an aluminum backing layer, and additionally comprising two adhesive layers, a first adhesive layer in between the outer layer and the middle layer, and a second adhesive layer between the middle layer and the backing layer, which are sandwiched together into a license plate.

The outer layer can have a variety of different optical structures, including but not limited to linear lenticular layers and a micro lens array, or other materials including moldable, flexible, transparent film material. Both of these types of optical structures can have either a convex or concave lens. It is also anticipated that the outer layer could cover all, or just some, of the license plate.

The outer layer can be manufactured by a number of processes, including but not limited to printing, stamping, laser writing, and others. Indeed, it is even anticipated that the optical structure could be generated on either the back of the outer layer, or the top of the middle layer. A preferred thickness range for the outer layer is between 20-200 um thickness.

### REFERENCE NUMBERS USED

1. Layer with optical structure
2. Adhesive
3. Information layer.
4. Retroreflective layer.
5. Base layer, preferably aluminum.
6. License plate
7. Section of micro-optical features.
8. Base layer depth.
9. Optical layer depth.
10. Optical layer reflection angle.
11. Retroreflective layer spacing.
12. Base layer top.

### DETAILED DESCRIPTION OF THE FIGURES

Many aspects of the invention can be better understood with references made to the drawings below. The components in the drawings are not necessarily drawn to scale. Instead, emphasis is placed upon clearly illustrating the components of the present invention. Moreover, like reference numerals designate corresponding parts through the several views in the drawings. Before explaining at least one embodiment of the invention, it is to be understood that the embodiments of the invention are not limited in their application to the details of construction and to the arrangement of the components set forth in the following description or illustrated in the drawings. The embodiments of the invention are capable of being practiced and carried out in various ways. In addition, the phraseology and terminology employed herein are for the purpose of description and should not be regarded as limiting.

FIG. 1 is a cross-sectional view of a license plate with a micro-optical outer surface, which is used in a preferred embodiment of the invention, but not in any way meant to limit the relevance of this claimed technology to other fields. In FIG. 1, there are three basic layers, a backing layer 4 which provides support for the license plate, a middle layer 3 which in this figure provides reflection such that the license plate is more visible at night, and an outer layer 2.

FIG. 2 is a front view of a license plate, showing a preferred embodiment of the invention.

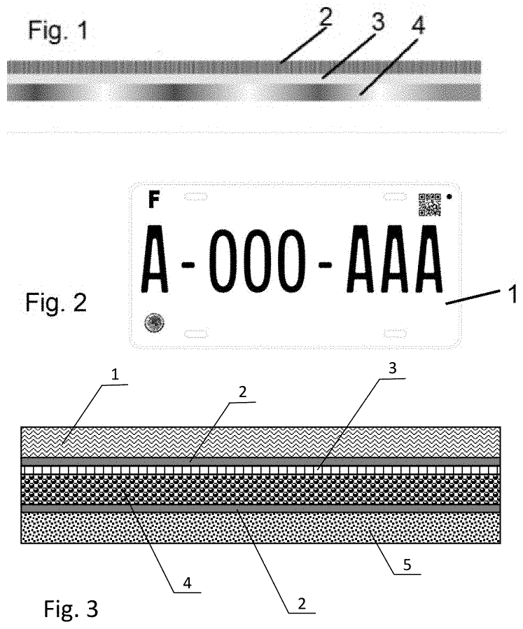

FIG. 3 is a cross-sectional view of another embodiment of the invention with five layers. The layer with optical structure 1, overlays the license plate and provides the anti-counterfeiting ability. An adhesive layer 2 retains the layer with optical structure 1 over an information layer 3, which has pertinent data such as numbers, state of registration, etc. The information layer 3 lays over the retroreflective layer 4, which is attached to a base layer 5 by another adhesive layer 2. The base layer is preferably aluminum.

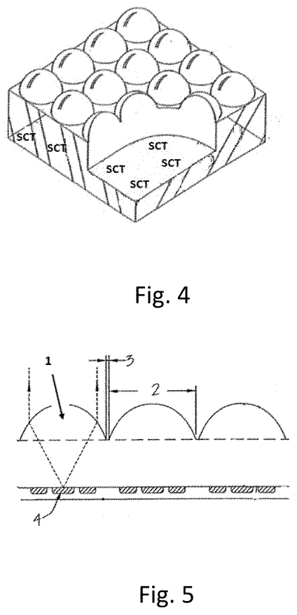

FIG. 4 is a perspective, partial cut-away view of the invention. The layer with optical structure is shown to have convex protuberances which create a dark area that is detectable by both traffic cameras and the naked eye.

FIG. 5 contains a cross-sectional view of one embodiment of the invention showing different lens aspects. The retroreflective layer 4 can be individual reflective units with retroreflective layer spacing 11, as shown here, or a complete surface of retroreflective elements. The base layer has a base layer depth 8, and the optical layer 1 has an optical layer depth 9. Light reflecting off the retroreflective layer 4 is bent as an optical layer reflection angle 10

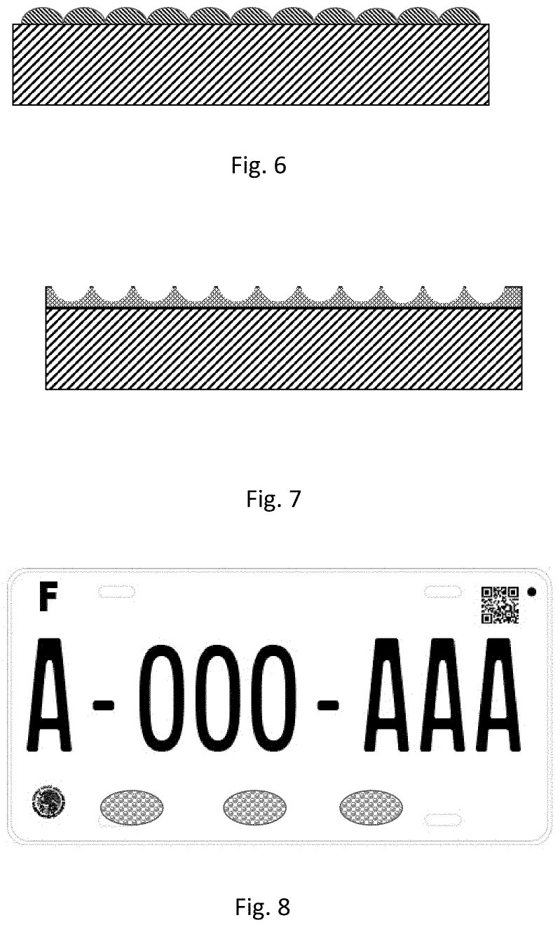

FIG. 6 contains a cross-sectional view of another embodiment of the invention showing different lens aspects.

FIG. 7 is a cross-sectional view of yet another embodiment of the invention showing different lens aspects.

FIG. 8 is a front view of a license plate with several optical structures 7 embedded in it.

In one particular embodiment of the idea, a device with superior visibility and anti-counterfeiting characteristics is provided, comprising: an outer layer, a middle layer and a backing layer, where the outer layer is comprises an optical structure, where the middle layer comprises an information layer and a reflective layer, and where the base layer is a backing layer, where the base layer is preferably aluminum. The device comprises two adhesive layers, a first adhesive layer in between the outer layer and the middle layer, and a second adhesive layer between the middle layer and the backing layer.

In a preferred embodiment, the device is a metal license plate, where the optical structure is one of, or a combination of, a linear lenticular layer, a micro lens array, a convex lens, and/or a concave lens. The retroreflective layer can cover the entire device, or just a portion of the device. The outer layer can be comprised of more than one material, including a moldable, flexible, transparent film material.

The optical structure on outer layer can be molded, embossed, cast, printed, stamped or created by laser writing. The information layer under the optical structure can be generated on the back of the outer layer or on a top surface of the middle layer. In a particularly preferred embodiment, the thickness is between 20-200 um thickness.

A preferred embodiment of the invention will now to discussed. A license plate with superior visibility, durability, appearance and anti-counterfeiting characteristics is proposed. The license plate comprises three basic layers: an outer layer, a middle layer and a backing layer. The backing layer is preferably aluminum or another lightweight yet strong metal, plastic or composite, and had the purpose of supporting the license plate. The middle layer is a reflective layer, which reflects light back, making the license plate more visible. The outer layer contains an optical structure, which can be made from a variety of materials and in a variety of shapes depending on the purpose for which the plate is made. In between the three layers are two adhesive layers, a first adhesive layer in between the outer layer and the middle layer, and a second adhesive layer between the middle layer and the backing layer. These adhesive layers server to bind the outer, middle and backing layer together in a sandwich fashion.

The outer layer has an optical structure, which can be a linear lenticular layer, a micro lens array, or any other kind of suitable optical structure. It is envisioned that the optical structure can be comprised of more than one material, and the more than one material includes at least a moldable, flexible, transparent film material. The optical structure can have a convex or concave lens, and can cover either the entire license plate, or just part of it. It is contemplated that the license plate can have multiple optical structures at different locations on the license plate.

The outer layer can be created through the process of printing, stamping, laser writing, or any other suitable process. Indeed, it is even contemplated that the information under the optical structure can be located on the back of the outer layer or on the top surface of the middle layer. In a particularly preferred embodiment, the outer layer has a thickness between 20-200 um thickness.

In another embodiment, illustrated in FIG. 3, layer with optical structure 1, overlays the license plate and provides the anti-counterfeiting ability. This layer can be places over the entire license plate, or only a portion. In the embodiments in which just a portion of the license plate is to be covered, the optical layer can be applied to only specific regions, or it can be applied to the entire license plate and then removed from the areas in which it is not desired. The optical layer 1 sits over the information layer 3, which overlies the retroreflective layer 4, which, in turns rests of the base layer. The basic layers can be attached to each other through one or more adhesive layers 2.

In yet another embodiment the license plate comprises an outer layer, a middle layer and a backing layer, where the outer layer is comprises an optical structure, where the middle layer comprises an information layer and a reflective layer, and where the base layer is a backing layer, where the base layer is aluminum. The various parts are held together by one or more adhesive layers, including, optionally, a first adhesive layer in between the outer layer and the middle layer, and a second adhesive layer between the middle layer and the backing layer.

The optical structure can be a linear lenticular layer, a micro lens array, a convex lens or a concave lens, and can cover either the entire surface of the license plate or only a portion. The license can have an outer layer that is comprised of more than one material, including a moldable, flexible, transparent film material, and can be molded, embossed, printed, stamped or created by laser writing.

It is contemplated that the information layer can be a separate layer, generated on the back of the outer layer, or generated on the top surface of a middle layer. In a particularly preferred embodiment, the outer layer has a thickness between 20-200 um thickness.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

That which is claimed:

1. A device with superior visibility and anti-counterfeiting characteristics, comprising: an outer layer, a middle layer and a backing layer, where the outer layer is comprises an optical structure, where the middle layer comprises an information layer and a reflective layer, and where the base layer is a backing layer.

2. The device of claim 1, where the base layer is aluminum.

3. The device of claim 2, additionally comprising two adhesive layers, a first adhesive layer in between the outer layer and the middle layer, and a second adhesive layer between the middle layer and the backing layer.

4. The device of claim 3, where the device is a metal license plate.

5. The device of claim 4, where the optical structure is a linear lenticular layer.

6. The device of claim 4, where the optical structure is a micro lens array

7. The device of claim 4, where the optical structure is a convex lens.

8. The device of claim 4, where the optical structure is a concave lens.

9. The device of claim 4, where the outer layer covers the entire device.

10. The device of claim 4, where the outer layer covers only a portion of the device.

11. The device of claim 4, where the outer layer is comprised of more than one material, and the more than one material includes at least a moldable, flexible, transparent film material.

12. The device of claim 11, where the optical structure on outer layer is molded.

13. The device of claim 11, where the optical structure on outer layer is embossed.

14. The device of claim 11, where the optical structure on outer layer is casted.

15. The device of claim 11, where the optical structure on outer layer is printed.

16. The device of claim 11, where the optical structure on outer layer is stamped.

17. The device of claim 11, where the optical structure on outer layer is created by laser writing.

18. The device of claim 11, where the information layer under the optical structure is generated on the back of the outer layer.

19. The device of claim 11, where the information layer under the optical structure is generated on a top surface of the middle layer.

20. The device of claim 1, where the outer layer has a thickness, and the thickness is between 20-200 um thickness.
